(19) United States
(12) Patent Application Publication
(10) Pub. No.: US 2023/0216553 A1
(43) Pub. Date: Jul. 6, 2023

(54) DEVICE AND METHOD FOR MULTI-USER TRANSMISSIONS

(71) Applicant: HUAWEI TECHNOLOGIES CO., LTD., Shenzhen (CN)

(72) Inventors: Oded REDLICH, Hod Hasharon (IL); Shimon SHILO, Hod Hasharon (IL); Jian YU, Shenzhen (CN); Doron EZRI, Hod Hasharon (IL); Avner EPSTEIN, Hod Hasharon (IL); Arik KLEIN, Hod Hasharon (IL); Genadiy TSODIK, Hod Hasharon (IL)

(73) Assignee: HUAWEI TECHNOLOGIES CO., LTD., Shenzhen (CN)

(21) Appl. No.: 18/181,765

(22) Filed: Mar. 10, 2023

Related U.S. Application Data
(63) Continuation of application No. PCT/EP2020/075519, filed on Sep. 11, 2020.

(51) Int. Cl. H04B 7/0452; H04B 7/06; H04W 72/563

(52) U.S. Cl. CPC H04B 7/0452; H04B 7/0628; H04W 72/563

(57) ABSTRACT

A wireless transmitting device is configured to: obtain a compressed-mode PPDU that includes one or more SC fields, where each SC field corresponds to one MU-MIMO group of the one or more MU-MIMO groups and is indicative of a spatial stream configuration for user devices of that MU-MIMO group; and transmit the PPDU to the user devices of the one or more MU-MIMO groups over a predetermined BW. Further, a user device is configured to: receive a compressed-mode PPDU from a wireless transmitting device; and decode the PPDU to obtain a SC field corresponding to the MU-MIMO group that the user device belongs to.

### CROSS-REFERENCE TO RELATED APPLICATIONS

This application is a continuation of International Application No. PCT/EP2020/075519, filed on Sep. 11, 2020, the disclosure of which is hereby incorporated by reference in its entirety.

### TECHNICAL FIELD

The embodiments relates to wireless communications, wireless transmissions for multiple users, and a device and method for multi-user (MU) transmissions in a compressed-mode.

### BACKGROUND

In the current 802.11ax standard, two modes of transmissions for multiple users are defined, i.e., “non-compressed mode” and “compressed mode”.

The non-compressed mode is used for most of the MU transmissions. In this case, the high-efficiency signal B (HE-SIG-B) field contains (besides other parts) a common part (as illustrated in FIG. 1), which contains resource unit (RU) allocation subfields to specify the RU assignment and the number of users per RU for each 20 MHz bandwidth (BW) segment. This common part describes the structure of the resource allocations in the physical layer protocol data unit (PPDU).

The compressed mode may be used when an access point (AP) transmits an MU PPDU to a group of users (up to 8 users) in an MU multiple-input multiple-output (MU-MIMO) scheme over the entire BW (e.g., 20 MHz, 40 MHz, 80 MHz, or 160 MHz). In this case, due to the definition of the PPDU format, the common field in the HE-SIG-B is redundant, hence, it can be omitted as shown in FIG. 2. As an outcome, the HE-SIG-B duration is reduced.

Notably, restrictions to a single group of users and full BW usage allow to reduce the signaling overhead in this mode. However, in case an AP wants to transmit a PPDU to two or more MU-MIMO groups of users, it can only use the non-compressed mode.

In the 802.11be standard, the maximum BW is increased to 320 MHz. Following the above restrictions means that the compressed mode can only be used for an entire BW of 320 MHz or 240 MHz, which is less efficient.

### SUMMARY

In view of the above-mentioned limitations, the embodiments aim to introduce a solution for enhancing a capability of MU-MIMO transmissions. In particular, an objective is to enable wireless transmissions to one or more MU-MIMO groups of users in a compressed- mode. One aim is thereby to save signaling overhead in MU transmissions.

The objective is achieved by the embodiments as provided in the embodiments.

A first aspect may provide a wireless transmitting device for transmitting one or more PPDUs to one or more MU-MIMO groups of user devices, the wireless transmitting device being configured to: obtain a compressed-mode PPDU that includes one or more spatial configuration (SC) fields, where each SC field corresponds to one MU-MIMO group of the one or more MU-MIMO groups and is indicative of a spatial stream configuration for user devices of that MU-MIMO group; and transmit the PPDU to the user devices of the one or more MU-MIMO groups over a predetermined BW.

The embodiments may expand the compression mode defined for 802.11ax (that is, allow the AP to transmit to a single group of up to 8 users in an MU-MIMO scheme over the entire BW), for a large BW combined with a simple OFDMA scheme, and thereby to enable one or more MU-MIMO groups (each has up to 8 users) to be served in a single PPDU with a lower signaling overhead.

In an implementation form of the first aspect, the one or more SC fields of the PPDU include a first SC field and a second SC field, where the first SC field corresponds to a first MU-MIMO group and the second SC field corresponds to a second MU-MIMO group.

Notably, each SC field represents a spatial stream configuration for user devices of one MU-MIMO group. This spatial stream configuration is shared by all user devices of that MU-MIMO group. Different SC fields correspond to different MU-MIMO groups. That is, the number of the SC fields may indicate the number of the MU-MIMO groups that served by the wireless transmitting device.

In an implementation form of the first aspect, where the PPDU includes one or more common fields and/or a user-specific field. The one or more common fields include one or more first information elements, where each first information element is to be used by all user devices of one associated MU-MIMO group. The user-specific field includes one or more second information elements, where each second information element is to be used by one associated user device.

Notably, the one or more common fields may carry information addressed to an MU-MIMO group, that is, the information may be identical for all user devices in the same MU-MIMO group. Further, it should be noted that the user-specific field may contain several fields called as “user-fields”. Each user-field within the user-specific field that does not correspond to a broadcast resource unit and does not correspond to an unassigned resource unit may carry only information addressed to an individual user device, the user device in the MU-MIMO group, that is, the information may be needed by one user device only.

In an implementation form of the first aspect, the one or more SC fields are included in at least one of the one and more common fields.

Optionally, the one or more SC field may be moved to common fields of the U-SIG/EHT-SIG. Notably, there may be 1 or 2 SC fields for user devices (of 1 or 2 MU-MIMO groups). Since all user devices are related to one of the SC fields, it may be a waste to repeat them in every single user-specific field for each user device (i.e., in each user-field). Thus, it may be desired, in some embodiments, to put the SC fields in the common field.

In an implementation form of the first aspect, wherein each SC field includes a plurality of entries, where each entry corresponds to one user device of the MU-MIMO group that the SC field corresponds to, and the entry is indicative of a number of spatial streams allocated to the user device that the entry corresponds to, and an index of each spatial stream of the MU-MIMO group.

Entries of the SC field may be arranged in order, such as in a descending order. For instance, the first SC field that corresponds to the first MU-MIMO group may be represented as [2 2 2 1 1 1 1]. There are seven elements in the set, each element corresponding to a user or can be used by a user. This indicates that the first 3 entries with value “2” refer to the user devices that have 2 spatial streams.

In an implementation form of the first aspect, where a second information element of the user-specific field of the PPDU includes at least one of a user position indication for the associated user device, and a user group indication for the associated user device. The user position indication is indicative of an index of an entry within the SC field that the associated user device may correspond to. The user group indication is indicative of the MU-MIMO group that the associated user device belongs to.

As previously mentioned, the user-specific field may contain several user-fields. The second information element defined here may be considered as a user-field. It is worth mentioning that the user position indication allows any user device to parse its own location within the corresponding SC field, without the need to decode other user-fields. Since one MU

MIMO group may have up to 8 user devices, 3 bits may be used to indicate a location of a user device. Notably, more than one SC field may be included in the compressed-mode PPDU. Therefore, in order to know which SC field is addressed to a particular user device, the user group indication is helpful.

In an implementation form of the first aspect, where a first information element of the one or more common signal fields of the PPDU includes a compression mode field indicative of a type of compression mode that is applied by the wireless transmitting device. The type of compression mode is indicative of how the predetermined BW is allocated to the one or more MU-MIMO groups.

Notably, the compression mode field carries information addressed to all user devices, thus it may be placed in the one or more common signal fields, particularly, it may even be placed in all common signal fields.

In an implementation form of the first aspect, the wireless transmitting device is further configured to transmit the PPDU to the user devices of the one or more MU-MIMO groups according to the type of compression mode.

In an implementation form of the first aspect, the type of compression mode includes at least one of the following: full bandwidth mode, and one of multiple enhanced compression modes, where each enhanced compression mode represents a resource allocation for the one or more MU-MIMO groups.

The wireless transmitting device may also support 802.11ax full BW compression mode. In addition, the wireless transmitting device can operate in the enhanced compression mode. There may be multiple types of the enhanced compression mode, and the wireless transmitting device may be configured to apply one or more of them. Notably, each enhanced compression mode represents one resource distribution for the one or more MU-MIMO groups.

In an implementation form of the first aspect, the predetermined BW includes a primary segment and one or more secondary segments.

In an implementation form of the first aspect, the resource allocation indicates which segment of the predetermined BW is allocated to which MU-MIMO group of the one or more MU-MIMO groups.

In an implementation form of the first aspect, if the resource allocation indicates that a first subchannel is allocated to the first MU-MIMO group and that a second subchannel is allocated to the second MU-MIMO group, the first subchannel including at least the primary segment, where information provided to user devices of the first MU-MIMO group is allocated in the first subchannel; and information provided to user devices of the second MU-MIMO group is allocated in a second subchannel. The second subchannel includes segments of the channel other than the segments included by the first subchannel.

It can be seen that the subchannels allocated to two MU-MIMO groups are not overlapping each other. It should be noted that “information” described here may refer to payload provided to user devices. It worth mentioning that signaling fields (e.g., one or more common fields) may be provided in any segment of the predetermined BW.

In an implementation form of the first aspect, the one or more SC fields are replicated over each segment of the predetermined BW.

If user devices also support parking mechanism, a user device that belongs to an MU-MIMO group may park in different segments. Thus, signaling addressed to all user devices may be replicated over each segment of the predetermined BW.

In an implementation form of the first aspect, the compression mode field is replicated over each segment of the predetermined BW.

As previously mentioned, the compression mode field is common to, and may also needed by, all user devices.

In an implementation form of the first aspect, where a first information element of the one or more common fields is indicative of a number of user devices in the associated MU-MIMO group.

In an implementation form of the first aspect, an indication of the number of user devices in each MU-MIMO group is replicated over each segment of the predetermined BW.

In an implementation form of the first aspect, the predetermined BW is 160 MHz, 240 MHz or 320 MHz.

A second aspect may provide a user device for an MU-MIMO group, the user device being configured to: receive a compressed-mode PPDU from a wireless transmitting device, which includes one or more SC fields, where each SC field corresponds to one MU-MIMO group and is indicative of a spatial stream configuration for user devices of that MU-MIMO group; and decode the PPDU to obtain a SC field corresponding to the MU-MIMO group that the user device belongs to.

The embodiments propose a user device of one MU-MIMO group that can operate accordingly as described in first aspect and its implementation forms.

In an implementation form of the second aspect, the user device is further configured to transmit a PPDU to the wireless transmitting device according to the spatial stream configuration of the SC field.

For instance, the user device may transmit an uplink PPDU to the wireless transmitting device, in particular, using the spatial streams allocated to it as indicated in the decoded SC field.

A third aspect may provide a method for a wireless transmitting device transmitting one or more PPDU to one or more MU-MIMO groups of user devices, the method including: obtaining a compressed-mode PPDU that includes one or more SC fields, where each SC field corresponds to one MU-MIMO group of the one or more MU-MIMO groups and is indicative of a spatial stream configuration for user devices of that MU-MIMO group; and transmitting the PPDU to the user devices of the one or more MU-MIMO groups over a predetermined BW.

Implementation forms of the method of the third aspect may correspond to the implementation forms of the wireless transmitting device of the first aspect described above. The method of the third aspect and its implementation forms may achieve the same advantages and effects as described above for the wireless transmitting device of the first aspect and its implementation forms.

A fourth aspect may provide a method for a user device of an MU-MIMO group, the method including: receiving a compressed-mode, PPDU, from a wireless transmitting device, which includes one or more SC field, where each SC field corresponds to one MU-MIMO group and is indicative of a spatial stream configuration for user devices of that MU-MIMO group; and decoding the PPDU to obtain a SC field corresponding to the MU-MIMO group that the user device belongs to.

Implementation forms of the method of the fourth aspect may correspond to the implementation forms of the user device of the second aspect described above. The method of the fourth aspect and its implementation forms may achieve the same advantages and effects as described above for the user device of the second aspect and its implementation forms.

A fifth aspect may provide a computer program product including a program code for carrying out, when implemented on a processor, the method according to the third aspect and any implementation forms of the third aspect, or the fourth aspect and any implementation forms of the fourth aspect.

It has to be noted that all devices, elements, units and the like could be implemented in the software or hardware elements or any kind of combination thereof. All steps which are performed by the various entities as well as the functionalities described to be performed by the various entities are intended to mean that the respective entity is adapted to or configured to perform the respective steps and functionalities. Even if, in the following description of the embodiments, a functionality or step to be performed by external entities is not reflected in the description of a detailed element of that entity which performs that step or functionality, it should be clear for a skilled person that these methods and functionalities can be implemented in respective software or hardware elements, or any kind of combination thereof.

### BRIEF DESCRIPTION OF THE DRAWINGS

The above-described aspects and implementation forms will be explained in the following description of the embodiments in relation to the enclosed drawings, in which

FIG. 1 shows a HE-SIG-B format in a non-compressed mode.

FIG. 2 shows a HE-SIG-B format in a compressed mode.

FIG. 3 shows an EHT (802.11be) frame format.

FIG. 4 shows a wireless transmitting device.

FIG. 5 shows a predefined bandwidth.

FIG. 6 shows an EHT-SIG for enhanced compressed mode.

FIG. 7 shows two MU-MIMO groups of users over BW=240 MHz.

FIG. 8 shows a user-field content.

FIG. 9 shows a user device.

FIG. 10 shows a method.

FIG. 11 shows another method.

### DETAILED DESCRIPTION OF THE EMBODIMENTS

Illustrative embodiments of methods, devices, and program product for MU transmissions in a communication system are described with reference to the figures. Although this description provides a detailed example of possible implementations, it should be noted that the details are intended to be exemplary and in no way limit the scope of the embodiments.

Moreover, an embodiment/example may refer to other embodiments/examples. For example, any description including, but not limited to, terminology, element, process, explanation and/or advantage mentioned in one embodiment/example is applicative to the other embodiments/examples.

In an MU-MIMO transmission scheme, the transmitter (e.g., AP) sends data to a group of users over the same frequency and time resources. Prior to using such transmission scheme, the transmitter may perform a grouping process in which it defines which users are grouped together and their respective frequency resources. This process may be done by applying some proprietary algorithms A user (e.g., a station (STA)) that belongs to an MU-MIMO group needs to extract certain parameters from a received signal, in order to correctly decode the received signal. The parameters may include: a number of total spatial streams transmitted in the MU-MINO signal, a number of spatial streams assigned to the user, or the indices (positions) of its spatial streams within the total spatial streams.

In 802.11ax, these parameters are signaled in the HE-SIG-B field. Optionally, the HE-SIG-B may contain a “user-specific field” which groups signaling portions for each user included in the current received signal. Each signaling portion may be named as “user-field” and may contain several parameters. Each user that is a part of a given PPDU is assigned with a single user-field, and each user is capable of identifying the single user-field of its own by identifying its own STA_ID which is one of these parameters. One of the other parameters, which is called as “spatial configuration (SC)”, exists only in user-fields of users that are part of an MU-MIMO group (user-field that are not associated with such users do not contain the SC field). This SC may be an array of up to eight entries, for instance in a descending order. The 802.11ax standard is defined as that, given the MU-MIMO group size, by extracting the SC, a user immediately understands the above-mentioned MU-MIMO parameters.

Any entry of the SC may correspond to one of the users in the MU-MIMO group. Both 802.11ax and 802.11be standards define that: the maximal group size (number of MU-MIMO users in the group) is 8, and the maximum number of spatial streams per user is 4.

In 802.11ax, the total spatial streams per MU-MIMO group is up to 8. Therefore, 4 bits are required to cover all combinations of spatial stream distributions for a given MU-MIMO group size (the group size is signaled in a separate field).

In 802.11be, the total spatial streams per MU-MIMO group is up to 16. Therefore, 6 bits are required to cover all combinations of spatial stream distributions for a given MU-MIMO group size.

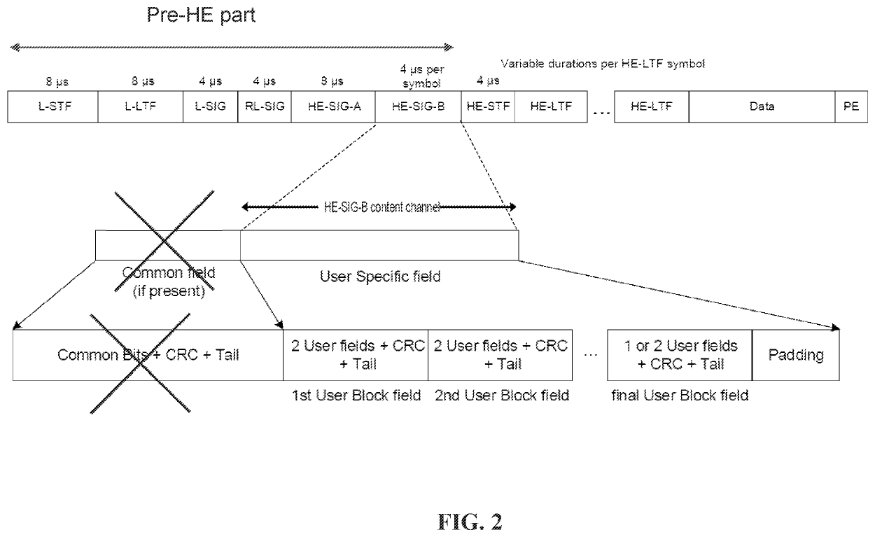

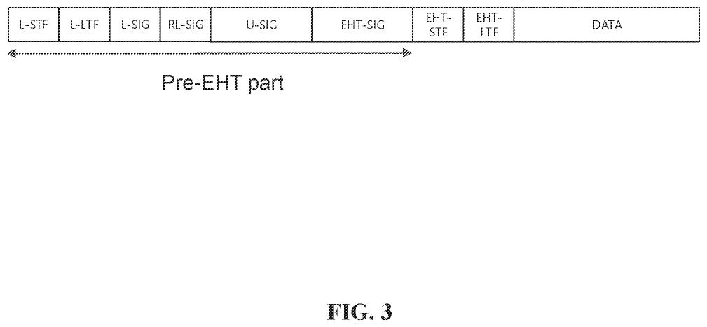

Further, 802.11 standards also discuss a “parking” mechanism. In 802.11ax, where the maximum BW is 160 MHz, any given user will process and decode the “Pre-HE” part (as shown in FIG. 2) on a primary channel (namely P80), even if there is a data RU assigned to that user outside P80 (i.e., in a secondary channel, namely S80 ). Pre-HE and pre-EHT (as shown in FIG. 2 and FIG. 3) are terms used to describe the series of fields used for training and signaling, e.g., channel estimation and signaling about the structure of the PPDU. Pre-HE and pre-EHT are parts of the PPDU preamble of 802.11ax and 802.11be, respectively, and are transmitted at the beginning of the PPDU.

In 802.11be, the BW may be extended to 320 MHz, however the user is still restricted to process and decode pre-EHT on no more than 80 MHz in the primary channel. This means that if the BW is 320 MHz, then the users that process pre-EHT on P80 are likely to be assigned a RU outside P80 (i.e., to any of the S80s). Notably, this is not an optimal situation.

The parking mechanism suggests that a user may not be restricted to receive and decode pre-EHT in P80, but instead it could “park” on one of the S80s and process pre-EHT there. In addition, it is likely that a user may park in a given segment but may be allocated a data RU in a different segment.

The embodiments may expand the compression mode defined for 802.11ax (that is, allow the AP to transmit to a single group of up to 8 users in an MU-MIMO scheme over the entire BW), for a large BW combined with a simple OFDMA scheme, thereby to enable two groups (each has up to 8 users) to be served in a single PPDU with lower signaling overhead.

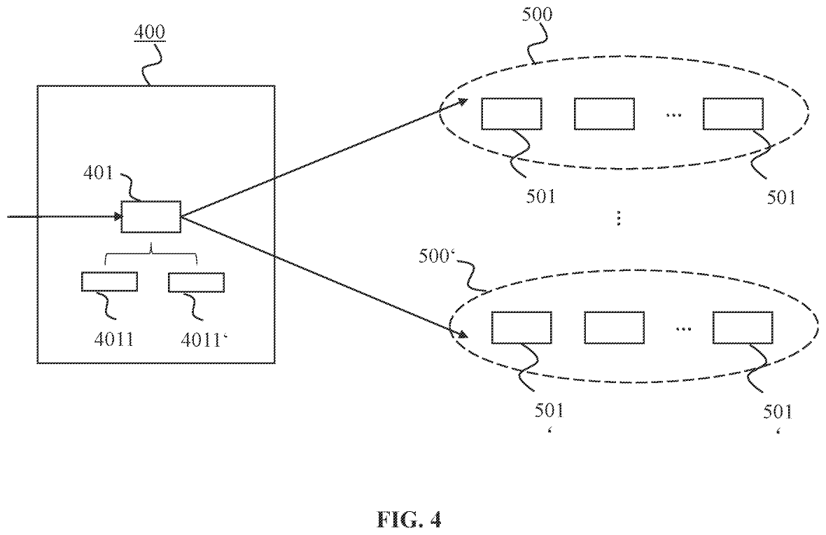

FIG. 4 shows a wireless transmitting device 400 according to an embodiment. The wireless transmitting device 400 may include processing circuitry (not shown) configured to perform, conduct, or initiate the various operations of the wireless transmitting device 400 described herein. The processing circuitry may include hardware and software. The hardware may include analog circuitry or digital circuitry, or both analog and digital circuitry. The digital circuitry may include components such as application-specific integrated circuits (ASICs), field-programmable arrays (FPGAs), digital signal processors (DSPs), or multi-purpose processors. The wireless transmitting device 400 may further include memory circuitry, which stores one or more instruction(s) that can be executed by the processor or by the processing circuitry, in particular under control of the software. For instance, the memory circuitry may include a non-transitory storage medium storing executable software code which, when executed by the processor or the processing circuitry, causes the various operations of the wireless transmitting device 400 to be performed. In one embodiment, the processing circuitry includes one or more processors and a non-transitory memory connected to the one or more processors. The non-transitory memory may carry executable program code which, when executed by the one or more processors, causes the wireless transmitting device 400 to perform, conduct or initiate the operations or methods described herein.

The wireless transmitting device 400 may transmit one or more PPDUs to one or more MU-MIMO groups 500, 500′ of user devices 501, 501′. The wireless transmitting device 400 is configured to obtain a compressed-mode PPDU 401 that includes one or more SC fields 4011, 4011′. Each SC field 4011 may correspond to one MU-MIMO group 500 of the one or more MU-MIMO groups 500, 500′. Each SC field 4011 is also indicative of a spatial stream configuration for user devices 501 of that MU-MIMO group 500. The wireless transmitting device 400 is further configured to transmit the PPDU 401 to the user devices 501, 501′ of the one or more MU-MIMO groups 500, 500′ over a predetermined BW.

In contrast to the conventional solution where a PPDU carries only information for a single MU-MIMO group when transmitting in compressed-mode, the embodiments may use a compress-mode PPDU 401, which can serve more than one MU-MIMO groups.

Optionally, the one or more SC fields of the PPDU may include a first SC field 4011 and a second SC field 4011′. In particular, the first SC field 4011 may correspond to a first MU-MIMO group 500, and the second SC field 4011′ may correspond to a second MU-MIMO group 500′. An MU-MIMO group may support up to 8 users. That is, the wireless transmitting device 400 may support up to 16 users (e.g., STAs) in 2 possible MU-MIMO RUs.

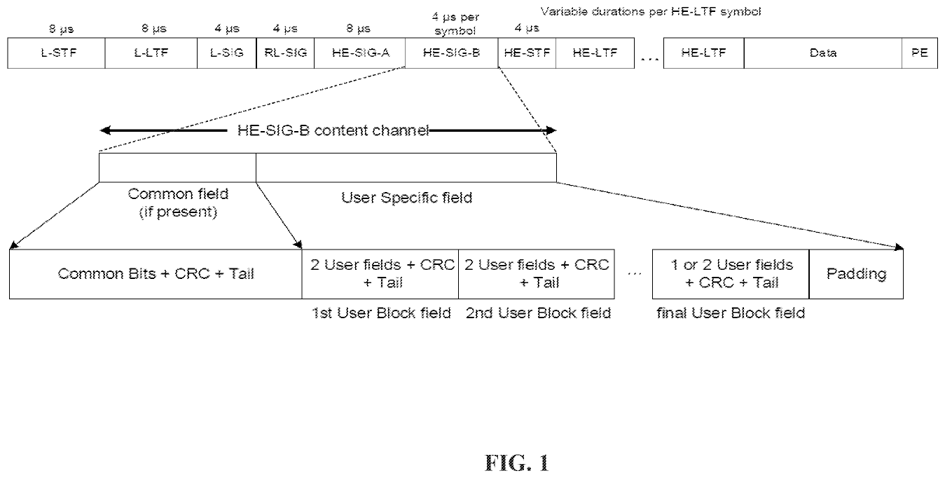

Optionally, according to an embodiment, the PPDU 401 may include one or more common fields and a user-specific field. For instance, the HE-SIG-B field includes a common field and a user-specific field, as shown in FIG. 1. For 802.11be standard, a universal SIG (U-SIG) field and an extremely high throughput signal (EHT-SIG) field both include a common field.

According to embodiments, the one or more common fields may include one or more first information elements, where each first information element is to be used by all user devices 501 of one associated MU-MIMO group 500. The user-specific field may include one or more second information elements, where each second information element is to be used by one associated user device 501.

Notably, according to an embodiment, the one or more SC fields 4011, 4011′ may be included in at least one of common fields. For instance, a SC field 4011 may be signaled in a common field of either the U-SIG or the EHT-SIG. It should be noted that the SC field 4011 may be removed from the user-specific field of the PPDU 401 in either way.

Optionally, each SC field 4011 includes a plurality of entries. Each entry may correspond to one user device 501 of the MU-MIMO group 500 that the SC field 4011 corresponds to, and the entry may be indicative of a number of spatial streams allocated to the user device 501 that the entry corresponds to, and an index of each spatial stream of the MU-MIMO group 500. For instance, if the first SC field 4011 that corresponds to the first MU-MIMO group 500 is represented as [2 2 2 1 1 1 1], this indicates that the first 3 entries with value “2” refer to the users that have 2 spatial streams.

Notably, in downlink transmissions, STAs may support full operating BW. For example, if the BW of a PPDU is 240 MHz/320 MHz, then all STAs allocated in the PPDU can support 240 MHz/320 MHz. Further, STAs may support parking mechanism as well.

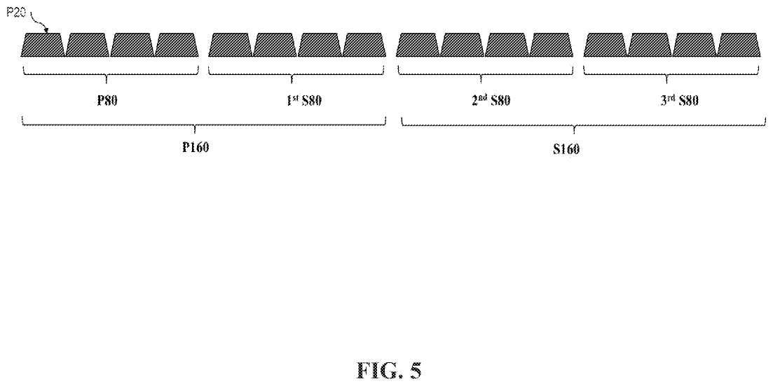

As previously mentioned, a given BW may include a primary channel and one or more secondary channels. FIG. 5 shows a predetermined BW according to an embodiment. Similar as in 802.11 standards, the predetermined BW may include a primary segment and one or more secondary segments. As shown in FIG. 5, if the predetermined BW is 320 MHz, the whole BW may be divided into a primary segment with 80 MHz (i.e., P80), and a 1st, 2^{nd}, and 3rd secondary segment each with 80 MHz (i.e., S80). Alternatively, the predetermined BW may be divided into a primary segment with 160 MHz (i.e., P160) and a secondary segment with 160 MHz (i.e., S160).

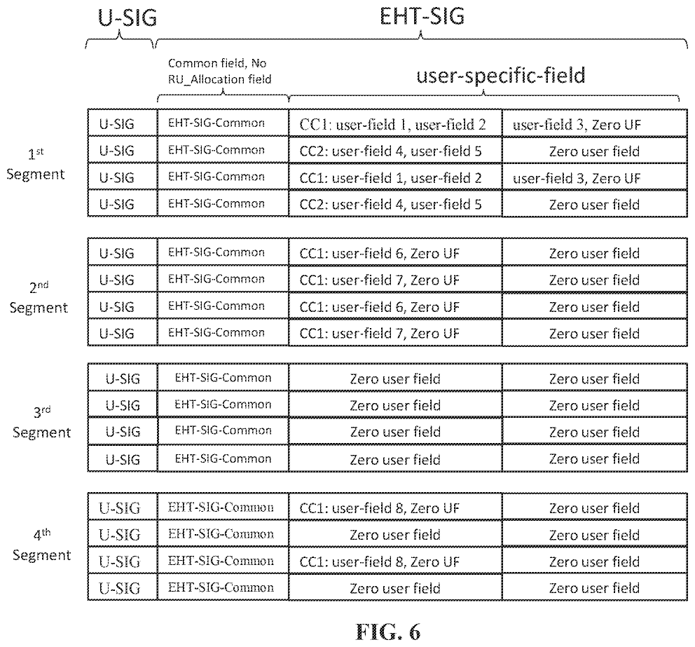

In an embodiment, the wireless transmitting device 400 may operate in a full BW compression mode. In this case, the wireless transmitting device 400 supports one MU-MIMO group 500, and thus may support up to 8 user devices 501. The wireless transmitting device 400 may transmit to the 8 user devices 501 over 240/320 MHz BW, where grouping may be imbalanced. For example, as shown in FIG. 6, there are 5 users parking on the first segment, while there is zero user parking on the third segment. Such as, the user fields of users 1-5, i.e., user-fields 1-5, may be transmitted on the subchannel(s) of the 1^{st} segment, while no user-field corresponding to an existing user is transmitted on the subchannel(s) of the 3rd segment. Notably, any user devices 501 may park on any segment.

Signaling in this scenario may be similar as defined in 802.11ax standard. Possibly, user-specific fields within each segment are equally split between content channels. The content channels may be used in order to split signaling of HE-SIG-B (in 802.11ax) and EHT-SIG (in 802.11be) between odd subchannels and even subchannels. For instance, Content channel #1 may contain signaling about the RU structures and the user-fields that correspond to subchannels 1, 3, 5, etc., (e.g., 20 MHz each). HE-SIG-B/EHT-SIG is therefore replicated in these subchannels. Content channel #2 may use the same principle for subchannels 2, 4, 6, etc. Such splitting may shorten the duration of HE-SIG-B/EHT-SIG. Notably, SC signaling, i.e., the SC field 4011, may locate in each user-specific field. Alternatively, the SC field 4011 may locate in common fields of at least one of the U-SIG and the EHT-SIG. Further, each user device 501 may need an indication about its position within the SC field 4011 due to lack of info about user devices 501 that park in other segments. Such indication may be included into each user-specific field.

FIG. 6 shows an EHT-SIG structure according to an embodiment. This structure may indicate parking locations of each user devices 501 in an MU-MIMO group 500. As illustrated in FIG. 6, in this embodiment, there are 5 user devices (user-field 1-5) parked in the 1st segment, 2 user devices (user-field 6-7) parked in the 2nd segment, 0 user device (0 user-field) parked in the 3rd segment, and 1 user devices (user-field 8) parked in the 4th segment.

For instance, if the SC field 4011 that corresponds to the MU-MIMO group 500 is [3 2 2 1 1 1 1 1], when parking mechanism is applied, then any user device 501 cannot know which of the entries within the SC field 4011 belongs to it. Thus, an individual user device 501 may need an index to point at the correct entry in order to extract its number of spatial streams and its indices within the MU-MIMO group 500.

Notably, the embodiments may enable the wireless transmitting device 400 to support an expanded compression mode or can be named as “an enhanced compression mode”.

According to an embodiment, the wireless transmitting device 400 may serve two MU-MIMO groups in the compressed-mode. That is, the wireless transmitting device 400 may transmit the compressed-mode PPDU to user devices 501 of the first MU-MIMO group 500 and user devices 501′ of the second MU-MIMO group 500′.

In such case, MU-MIMO allocations may contain 2 RUs that span the entire BW, i.e., the predetermined BW, as shown in FIG. 5 for instance. That is, the predetermined BW may be allocated to the first MU-MIMO groups 500 and the second MU-MIMO group 500′. It should be noted that the resource may be allocated to the two MU-MIMO groups 500, 500′ in different ways. That is, the enhanced compression mode may have different implementations.

For instance, when the predetermined BW is 320 MHz, the RUs may be allocated in one of the following manners:
a. 1st RU (allocated to a first MU-MIMO group 500)=P80, 2nd RU (allocated to a second MU-MIMO group 500′)=1st S80+S160;
b. 1st RU=P160, 2nd RU=S160;
c. 1st RU=P160+2nd S80, 2nd RU=3rd S80;
d. 1st RU=P160+3rd S80, 2nd RU=2nd S80;
e. 1st RU=P80+2nd S80, 2nd RU=1st S80+3rd S80;
f. 1st RU=P80+3rd S80, 2nd RU=1st S80+2nd S80.

Similarly, when the predetermined BW is 240 MHz, the RUs may be allocated in one of the following manners:
a. 1st RU=P80, 2nd RU=1st S80+2nd S80;
b. 1st RU=P160, 2nd RU=2nd S80;
c. 1st RU=P80+2nd S80, 1st RU=1st S80.

It should be noted that besides the resources allocated for the MU-MIMO groups, for instance the first MU-MIMO groups 500 and the second MU-MIMO group 500′, there are no other resources left for other devices. That is, there are no portion of the available channel that are left unallocated.

According to the embodiments, in order to signal a MU-MIMO allocation to user device 501, 501′, the wireless transmitting device 400 should indicate a type of the enhanced compression mode to the user device 501, 501′.

Optionally, according to an embodiment, a first information element of the one or more common signal fields of the PPDU 401 may include a compression mode field indicative of a type of compression mode that is applied by the wireless transmitting device 400. The type of compression mode may be indicative of how the predetermined BW is allocated to the one or more MU-MIMO groups 500, 500′.

Possibly, the type of compression mode may include full BW mode, and/or an enhanced compression mode. When the wireless transmitting device 400 operates in the full BW mode, it may act similarly as in a conventional solution. It should be noted that the enhanced compression mode refers to the compression mode proposed according to the embodiments, that is, the expanded compression mode for large BW combined with a simple OFDMA scheme. As previously described, there may be multiple types of the enhanced compression mode, and the wireless transmitting device 400 may apply one of them. According to the embodiments, each enhanced compression mode represents a resource allocation for the one or more MU-MIMO groups 500, 500′. Each enhanced compression mode may define a way of splitting the entire BW to at least two MU-MIMO groups 500, 500′.

Optionally, the wireless transmitting device 400 may be configured to transmit the PPDU 401 to the user devices 501, 501′ of the one or more MU-MIMO groups 500, 500′ according to the type of compression mode.

Optionally, if the resource allocation indicates that a first subchannel is allocated to the first MU-MIMO group 500 and that a second subchannel is allocated to the second MU-MIMO group 500′, the first subchannel including at least the primary segment (e.g., as shown in FIG. 5). Information provided to user devices 501 of the first MU-MIMO group 500 may be allocated in the first subchannel; and information provided to user devices 501′ of the second MU-MIMO group 500′ may be allocated in a second subchannel. It should be noted that the first subchannel and the second subchannel are not overlapped. That is, the second subchannel may include segments of the predetermined BW other than the segments included by the first subchannel.

That is, the resource allocation indicates which segment of the predetermined BW is allocated to which MU-MIMO group of the one or more MU-MIMO groups 500, 500′. According to an embodiment, for 240 MHz 3 entries in either U-SIG or EHT-SIG common field may be required as described in Table 1.

TABLE 1
Compression mode field for BW = 240 MHz

| Compression | MU-MIMO RUs structure | |
|---|---|---|
| field | (1^{st} RU, 2^{nd} RU) | Remark |
| 000 | Non compressed mode | Similar to |
| 001 | Full BW | 802.11ax |
| 010 | P80, 1^{st} S80 + 2^{nd} S80 | Extension MU- |
| 011 | P160, 2^{nd} S80 | MIMO RUs for |
| 100 | P80 + 2^{nd} S80, 1^{st} S 80 | 802.11 OFDMA |
| 101-111 | Reserved | compressed-mode |

According to another embodiment, for 320 MHz 6 entries in either U-SIG or EHT-SIG common field may be required as described in Table 2.

TABLE 2
Compression mode field for BW = 320 MHz

| Compression | MU-MIMO RUs structure | |
|---|---|---|
| field | (1^{st} RU, 2^{nd} RU) | Remark |
| 000 | Non compressed mode | Similar to |
| 001 | Full BW | 802.11ax |
| 010 | P80, 1^{st} S80 + S160 | Extension MU- |
| 011 | P160, S160 | MIMO RUs for |
| 100 | P160 + 2^{nd} S80, 3^{rd} S80 | 802.11 OFDMA |
| 101 | P160 + 3^{rd} S80, 2^{nd} S80 | compressed-mode |
| 110 | P80 + 2^{nd} S80, 1^{st} S80 + 3^{rd} S80 | |
| 111 | P80 + 3^{rd} S80, 1^{st} S80 + 2^{nd} S80 | |

According to another embodiment, for 320 MHz and 240 MHz a single entry in either U-SIG or EHT-SIG common field may be required as described in Table 3. In this embodiment, a single OFDMA structure is defined and used. Thus, the size of the compression field may be reduced to 2 bits. For instance, 240 MHz can be achieved by not using one of the 80 MHz secondary segments.

TABLE 3
Compression mode field for BW = 320 MHz/240 MHz
with a single OFDMA allocation

| Compression | MU-MIMO RUs structure | Remark |
|---|---|---|
| field | (1^{st} RU, 2^{nd} RU) | |
| 00 | Non compressed mode | Similar to |
| 01 | Full BW | 802.11ax |
| 10 | P160, S160 | Extension MU-MIMO |
| | | RUs for 802.11 |
| 11 | Reserved | OFDMA compressed-mode |

It is worth mentioning that the above MU-MIMO RUs may still be applied to a case of using multiple RUs due to the unavailability of some of the 20 MHz portions of the predetermined BW. In such case, one or more segments may be partially used as defined in the 802.11be standard.

Further, the embodiments may not force an additional restriction on the MU-MIMO grouping algorithm. Any MU-MIMO group 500, 500′ may contain user devices 501, 501′ that park in any segment.

When parking mechanism is applied, then any given user devices 501, 501′ cannot know which of the entries within the SC field belongs to it. Accordingly, both of the user devices 501 of the first MU-MIMO group 500 and the user devices 501′ of the second MU-MIMO group 501′, may need an index to point at the correct entry to extract its own number of spatial streams and its index within the corresponding MU-MIMO group 500, 500′.

Optionally, according to an embodiment, a second information element of the user-specific field of the PPDU 401 may include at least one of a user position indication for the associated user device 501, 501′ and a user group indication for the associated user device 501, 501′. The user position indication may be indicative of an index of an entry within the SC field 4011, 4011′ that the associated user device 501, 501′ corresponds to. The user group indication is indicative of the MU-MIMO group 500, 500′ that the associated user device 501, 501′ belongs to.

The user position indication, which may also be referred to as “STA position in SC”, allows any user device 501 to parse its own location within the SC field 4011 without the need to decode other user-fields (such as in other segments, which may be impossible). The user group indication may also be referred to as “User SC indication”. Since there may be two or more SC fields 4011, 4011′ (corresponding to two or more MU-MIMO group 500, 500′), and all SC field 4011, 4011′ are transmitted in all segments, each user device 501, 501′ beneficially knows, which one of the SC field 4011, 4011′ is related to it (i.e., which MU-MIMO group 500, 500′ it belongs to).

As previously mentioned, a user device 501, 501′ that belongs to an MU-MIMO group 500, 501′ may park in different segments. Thus, some information in the one or more common fields may be replicated over each segment of the predetermined BW.

For instance, the compression mode field may be replicated over each segment of the predetermined BW in either U-SIG or in the common part of EHT-SIG. This field may include maximum of 3 bits as shown in Table 1 and Table 2. Possibly, the number of bits may be less, if less MU-MIMO RUs combinations are defined as shown in Table 3.

Further, the one or more SC fields 4011, 4011′ may be replicated over each segment of the predetermined BW as well. SC fields for two MU-MIMO RUs may include 12 bits, where 6 bits for each SC field as defined in 802.11be standard. Optionally, an indication about the number of user devices 501, 501′ in each MU-MIMO group 500, 500′ may be replicated over each segment of the predetermined BW. This information may be included in the one or more common fields. For instance, for each MU-MIMO RU, 3 bits may be needed to indicate the number of user devices 501, 501′. Optionally, a number of EHT-SIG symbols (e.g., 3 bits) may also be replicated over each segment of the predetermined BW. Notably, these symbols may be signaled in the EHT-SIG field, or in the U-SIG field.

Notably, some other signaling fields may be placed in the user-specific field of the PPDU 401. For instance, a STA_ID (i.e., 11 bits) that identifies the user device 501, 501′, a modulation and coding scheme (MCS) (e.g., 4 bits), a coding (e.g., 1 bit), the user position indication (e.g., 3 bits), and/or the user group indication (e.g., 1 bit) may be placed in the user-specific field. In one MU-MIMO group 500, 500′ there may be up to 8 user devices 501, 501′, thus 3 bits may be used to indicate a location of a user device 501 in the MU-MIMO group 500. The 1 bit of the user group indication indicates whether the user device 501, 501′ takes the SC field corresponding to the first MU-MIMO group 500 (may be represented as ‘0’) or the second MU-MIMO group 500′ (may be represented as ‘1’). Notably, in the case that more than 2 MU-MIMO groups are defined, more than 1 bit for the user group indication will be required, for instance 2 or 3 bits.

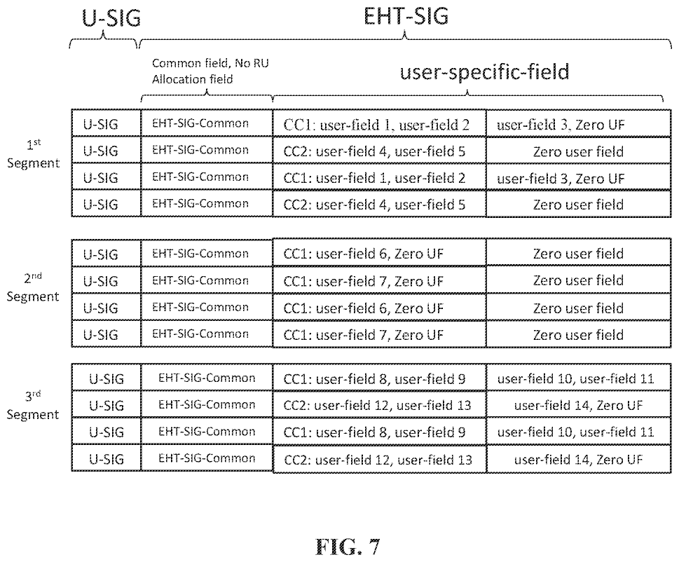

FIG. 7 shows another EHT-SIG structure according to an embodiment. In this embodiment, user devices 501, 501′ of two MU-MIMO groups 500, 500′ are served over a BW of 240 MHz. It should be noted that the following content are provided as an example for understanding, but not for limiting the embodiments.

As depicted in FIG. 7, there are 14 users (e.g., user devices 501, 501′) with the following arbitrary distribution to 2 groups (e.g., the first MU-MIMO group 500 and the second MU-MIMO group 500′). Each user-field X (i.e., user-specific field) corresponds to user X. Group 1 (e.g., data transmitted in P160 as shown in FIG. 5) includes users 1, 3, 5, 7, 9, 11 and 13; Group 2 (e.g., data transmitted in S80) includes users 2, 4, 6, 8, 10, 12 and 14. Parking location of each user can be seen as shown in FIG. 7. It should be noted that there is no restriction between the parking locations and the grouping distribution.

For instance, a spatial streams distribution in Group 1 can be considered as: for users 1, 5, and 7: 2 spatial streams; for users 3, 9, 11 and 13: 1 spatial stream. Accordingly, a corresponding SC field can be represented as [2 2 2 1 1 1 1].

Similarly, if a spatial streams distribution in Group 2 can be considered as: for user 8: 3 spatial streams; for users 2, 6 and 12: 2 spatial stream; for users 4, 10 and 14: 1 spatial stream. Accordingly, a corresponding SC field can be represented as [3 2 2 2 1 1 1].

According to the embodiment, both of the SC fields should be signaled in all segments. Their 12 bits content corresponds to [2 2 2 1 1 1 1], [3 2 2 2 1 1 1].

“User SC indication” field (i.e., the user group indication) in each user-field is used as a pointer to the correct SC. For instance, in 1st segment: users 1, 3 and 5 belong to Group 1, therefore for these users the “User SC indication” is ‘0’; and users 2, 4 and 6 belong to Group 2, therefore for these users the “User SC indication ” is ‘1’. Similarly, in 2^{nd} segment, user 7 belongs to Group 1 therefore for user 7 the “User SC indication” is ‘0’; and user 8 belongs to Group 2 therefore for user 8 the “User SC indication” is ‘1’. In 3^{rd} segment, for users 9, 11 and 13 the “User SC indication” is ‘0’, and for users 10, 12 and 14 the “User SC indication” is ‘1’.

“STA position in SC” field (i.e., the user position indication) indicates an index of an entry in SC field that corresponds to the user. In this embodiment, it is known that the SC field corresponding to Group 1 is [2 2 2 1 1 1 1], and the first 3 entries with value “2” refer to the users that have 2 spatial streams, i.e., users 1 (first in SC), 5 (second in SC) and 7 (third in SC). Therefore, for these 3 users in Group 1, their “STA position in SC” content can be: 000 for user 1, 001 for user 5, and 010 for user 7.

In a similar way, the content of “STA position in SC” for the rest of the users in Group 1 may be as: 011 for user 3, 100 for user 9, 101 for user 11 and 110 for user 13.

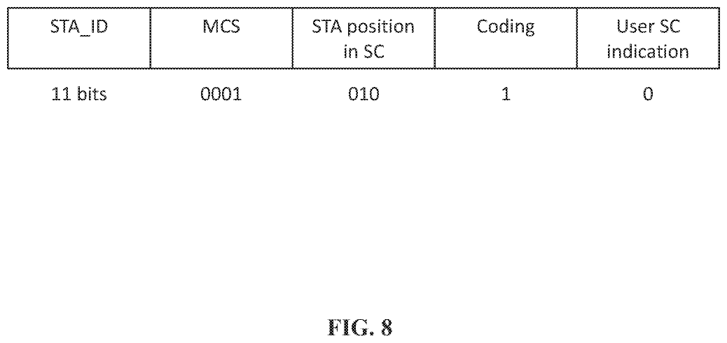

FIG. 8 shows a user-field content of user 7 according to the embodiment described with respect to FIG. 7. As shown in FIG. 7, the content of user-field 7 is transmitted in 2^{nd} segment (assuming using MCS-1, LDPC for the transmission). Accordingly, “STA position in SC” of user 7 may be represented as “010”, i.e., to indicate a position of user 7 in the corresponding SC field is 3. Further, “User SC indication” of user 7 may be ‘0’, to show that user 7 belongs to Group 1.

Table 4 shows a content of “STA position in SC” and “User SC indication” corresponding to each users of Group 1 and Group 2, according to the embodiment.

TABLE 4
Parameters for user devices of MU-MIMO groups

| | Number of | position | User SC |
|---|---|---|---|
| STA | spatial streams | in SC | indication |
| 1 | 2 | 000 | 0 |
| 2 | 2 | 001 | 1 |
| 3 | 1 | 011 | 0 |
| 4 | 1 | 100 | 1 |
| 5 | 2 | 001 | 0 |
| 6 | 2 | 010 | 1 |
| 7 | 2 | 010 | 0 |
| 8 | 3 | 000 | 1 |
| 9 | 1 | 100 | 0 |
| 10 | 1 | 101 | 1 |
| 11 | 1 | 101 | 0 |
| 12 | 2 | 011 | 1 |
| 13 | 1 | 110 | 0 |
| 14 | 1 | 110 | 1 |

As previously defined, the SC fields of this embodiment can be represented as [2 2 2 1 1 1 1], [3 2 2 2 1 1 1]. When user 5 (i.e., STA 5) decodes its parameters in its corresponding user-field, it can extract the STA position in SC=001, and User SC indication =0. “User SC indication”=0 means user 5 belongs to Group 1, thus its corresponding SC field is [2 2 2 1 1 1 1]. This also indicates that there are in total 10 spatial streams transmitted to this group. Further, its position in SC is 2 (i.e., 001), therefore its number of spatial streams is 2 and the indices for its spatial streams are 3 and 4. Notably, this is because that the user in position 1 has 2 spatial streams as well, so indices of these two spatial streams are 1 and 2.

To summarize, the embodiments may enable grouping STAs that support a large BW into one or more MU-MIMO allocations. If a single MU-MIMO allocation is defined over the entire BW, the solution may be similar to 801.11ax full BW compression mode, with extra addressing parking mechanism for the STAs. If two MU-MIMO allocations are defined, the first MU-MIMO allocation may span P160, while the second MU-MIMO allocation spans S80/S160 (for BW=240/320 MHz). According to the embodiments, subfields for resource allocation can be omitted, thereby minimizing a size of the EHT-SIG common field.

In addition, the embodiments may move the SC field to common fields of the U-SIG/EHT-SIG. Notably, there may be 1 or 2 SC fields for STAs (for 1 or 2 groups). Since all STAs are related to one of the SC fields, it may be a waste to repeat them in all user-fields. Thus, it may be desired to put the SC fields in the common field. Further, the embodiments may leave the SC fields in the user-fields as used in 802.11ax, to preserve 802.11ax full BW compression mode.

Some indications are added to the user-fields to enable getting all necessary MU-MIMO parameters. This may be desired when allowing STAs that belong to the same MU-MIMO group to park in different segments. It is worth mentioning that, since the SC field (6 bits for one STA, since only SC of one group is needed) can be removed from the user-field, even 4 extra bits for signaling the relevant indications may be added into the user-field, 2 bits can still be saved in each user-field.

Other MU-MIMO parameters may also signaled in U-SIG or EHT-SIG-common field, such as a number of EHT-SIG symbols, and/or a number of MU-MIMO users (in each group or in all groups).

It can be seen that, for serving 16 STAs in 2 MU-MIMO RUs over 320 MHz, 82 bits may be saved by omitting a resource allocation table (assuming 9 bits per resource allocation subfield). As above mentioned that 2 bits can be saved in each user-field, consequently, in total 16-32 bits (depends on parking location of all STAs) of the EHT-SIG may be saved for one PPDU. Even 12 bits for two SC fields (for two groups), 6 bits for the number of MU-MIMO users, and/or up to 2 bits for the type of enhanced compression mode are newly added, an overall overhead is still reduced. In an embodiment, an overall overhead can be expected to be saved by 78-94 bits.

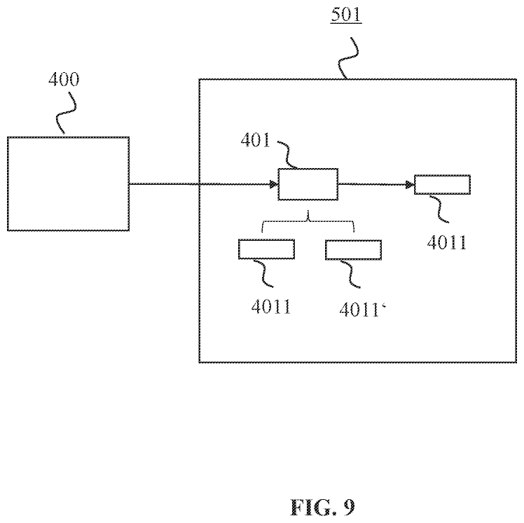

FIG. 9 shows a user device 501 according to an embodiment. The user device 501 may include processing circuitry (not shown) configured to perform, conduct or initiate the various operations of the user device 501 described herein. The processing circuitry may include hardware and software. The hardware may include analog circuitry or digital circuitry, or both analog and digital circuitry. The digital circuitry may include components such as application-specific integrated circuits (ASICs), field-programmable arrays (FPGAs), digital signal processors (DSPs), or multi-purpose processors. The user device 501 may further include memory circuitry, which stores one or more instruction(s) that can be executed by the processor or by the processing circuitry under control of the software. For instance, the memory circuitry may include a non-transitory storage medium storing executable software code which, when executed by the processor or the processing circuitry, causes the various operations of the user device 501 to be performed. In one embodiment, the processing circuitry includes one or more processors and a non-transitory memory connected to the one or more processors. The non-transitory memory may carry executable program code which, when executed by the one or more processors, causes the user device 501 to perform, conduct or initiate the operations or methods described herein.

The user device 501 shown in FIG. 9 may belong to an MU-MIMO group 500. The user device 501 is configured to receive a compressed-mode PPDU 401 from a wireless transmitting device 400. The wireless transmitting device 400 shown in FIG. 9 may be the wireless transmitting device shown in FIG. 4. The PPDU 401 may include one or more SC fields 4011, 4011′. Each SC field 4011, 4011′ corresponds to one MU-MIMO group 500, 500′. Each SC field 4011, 4011′ is also indicative of a spatial stream configuration for user devices 501, 501′ of that MU-MIMO group 500, 500′. The user device 501 is further configured to decode the PPDU 401 to obtain a SC field 4011 corresponding to the MU-MIMO group 500 that the user device 501 belongs to.

Notably, the user device 501 shown in FIG. 9 may be one of the user devices 501, 501′ shown in FIG. 4. That is, the user device 501 may operate accordingly as described in the previous embodiments.

Optionally, according to an embodiment, the user device 501 may be further configured to transmit a PPDU to the wireless transmitting device 400 according to the spatial stream configuration of the SC field 4011. For instance, the user device 501 may transmit an uplink PPDU to the wireless transmitting device 400 using the spatial streams allocated to it, as indicated in the SC field 4011.

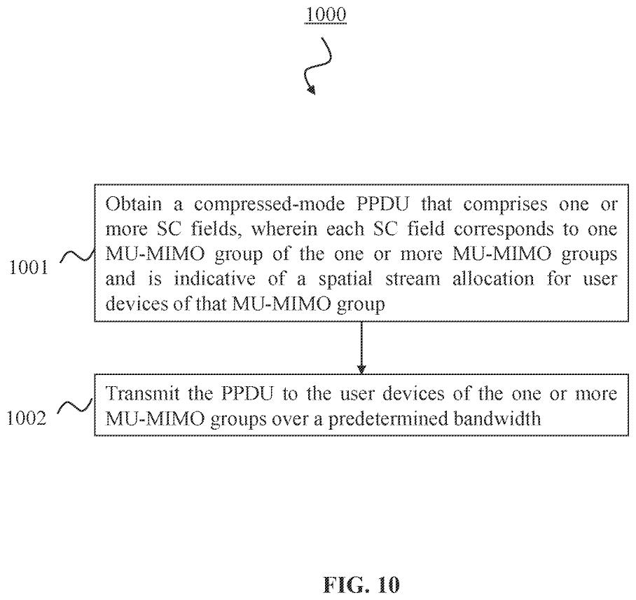

FIG. 10 shows a method 1000 according to an embodiment. The method 1000 may be performed by a wireless transmitting device 400 shown in FIG. 4. The method 1000 includes: a step 1001 of obtaining a compressed-mode PPDU 401 that includes one or more SC fields 4011, 4011′. In particular, each SC field 4011 corresponds to one MU-MIMO group 500 of the one or more MU-MIMO groups 500, 500′ and is indicative of a spatial stream configuration for user devices 501 of that MU-MIMO group 500. Possibly, each SC field 4011′ may correspond to another MU-MIMO group 500′ of the one or more MU-MIMO groups 500, 500′. The method 1000 further includes a step 1002 of transmitting the PPDU 401 to the user devices 501, 501′ of the one or more MU-MIMO groups 500, 500′ over a predetermined BW. Possibly, the user device 501 is the user device shown in FIG. 4 or FIG. 9.

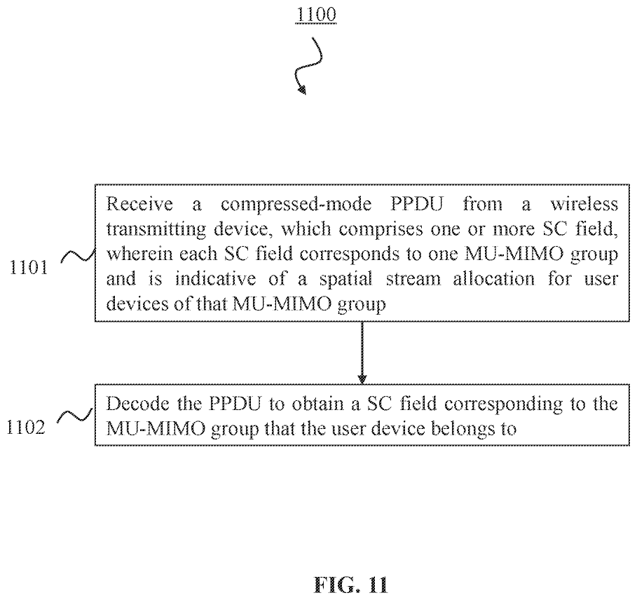

FIG. 11 shows a method 1100 according to an embodiment. The method 1100 may be performed by a user device 501 shown in FIG. 9. The method 1100 includes: a step 1101 of receiving a compressed-mode PPDU 401 from a wireless transmitting device 400. The PPDU 401 may include one or more SC fields 4011, 4011′, where each SC field 4011 corresponds to one MU-MIMO group 500 of the one or more MU-MIMO groups 500, 500′ and is indicative of a spatial stream configuration for user devices 501 of that MU-MIMO group 500. The method 1100 further includes a step 1102 of decoding the PPDU 401 to obtain a SC field 4011 corresponding to the MU-MIMO group 500 that the user device 501 belongs to. Possibly, the wireless transmitting device 400 is the wireless transmitting device shown in FIG. 4 or FIG. 9.

The embodiments have been described in conjunction with various embodiments as examples as well as implementations. However, other variations can be understood and effected by those persons skilled in the art from the studies of the drawings and the embodiments. The indefinite article “a” or “an” does not exclude a plurality. A single element or other unit may fulfill the functions of several entities or items recited in the embodiments. The mere fact that certain measures are recited in the mutual different embodiments does not indicate that a combination of these measures cannot be used in an advantageous implementation.

Furthermore, any method according to the embodiments may be implemented in a computer program, having code, which when run by a processor causes the processor to execute the steps of the method. The computer program is included in a computer readable medium of a computer program product. The computer readable medium may include essentially any memory, such as a ROM (Read-Only Memory), a PROM (Programmable Read-Only Memory), an EPROM (Erasable PROM), a Flash memory, an EEPROM (Electrically Erasable PROM), or a hard disk drive.

Moreover, it is realized by the skilled person that embodiments of the wireless transmitting device 400 and the user device 501, respectively, includes the necessary communication capabilities in the form of e.g., functions, units, elements, etc., for performing the solution. Examples of other such units, elements and functions are: processors, memory, buffers, control logic, encoders, decoders, rate matchers, de-rate matchers, mapping units, multipliers, decision units, selecting units, switches, interleavers, de-interleavers, modulators, demodulators, inputs, outputs, antennas, amplifiers, receiver units, transmitter units, DSPs, trellis-coded modulation (TCM) encoder, TCM decoder, power supply units, power feeders, communication interfaces, communication protocols, etc. which are suitably arranged together for performing the solution.

The processor(s) of the wireless transmitting device 400 and the user device 501, respectively, may include, e.g., one or more instances of a Central Processing Unit (CPU), a processing unit, a processing circuit, a processor, an application specific integrated circuit (ASIC), a microprocessor, or other processing logic that may interpret and execute instructions. The expression “processor” may thus represent a processing circuitry including a plurality of processing circuits, such as, e.g., any, some or all of the ones mentioned above. The processing circuitry may further perform data processing functions for inputting, outputting, and processing of data including data buffering and device control functions, such as call processing control, user interface control, or the like.

A communications apparatus (for example a station or an access point which can perform the above method) is provided, including at least one of the following: a bus, a processor, a storage medium, a bus interface, a network adapter, a user interface, and an antenna (or a transceiver, transmitter and/or receiver), where the bus is configured to connect the processor, the storage medium, the bus interface, and the user interface; the processor is configured to perform the above method; the storage medium is configured to store an operating system and to-be-sent or to-be-received data; the bus interface is connected to the network adapter; the network adapter is configured to implement a signal processing function of a physical layer in a wireless communications network; the user interface is configured to be connected to a user input device; and the antenna is configured to send and receive a signal.

Another aspect may provide a non-transitory computer-readable storage medium, where the non-transitory computer-readable storage medium stores an instruction, and when the non-transitory computer-readable storage medium runs on a computer, the computer performs the above method.

Another aspect may provide a computer program product including an instruction, where when the computer program product runs on a computer, the computer performs the above method.

Another aspect may provide a computer program, where when the computer program runs on a computer, the computer performs the above method.

The foregoing embodiments may be all or partially implemented by using software, hardware, firmware, or any combination thereof. When software is used to implement the embodiments, the embodiments may be all or partially implemented in a form of a computer program product. The computer program product includes one or more computer instructions. When the computer program instructions are loaded and executed on a computer, the procedures or functions according to the embodiments are all or partially generated. The computer may be a general-purpose computer, a dedicated computer, a computer network, or other programmable apparatuses. The computer instructions may be stored in a non-transitory computer readable storage medium or may be transmitted from a non-transitory computer readable storage medium to another non-transitory computer readable storage medium. For example, the computer instructions may be transmitted from a website, computer, server, or data center to another website, computer, server, or data center in a wired (for example, a coaxial cable, an optical fiber, or a digital subscriber line (DSL)) or wireless (for example, infrared, radio, or microwave) manner The computer readable storage medium may be any usable medium accessible by a computer, or may be a data storage device, such as a server or a data center, integrating one or more usable media.

1. A wireless transmitting device for transmitting one or more physical layer protocol data units (PPDUs) to one or more multi-user multi-input multi-output, (MU-MIMO), groups of user devices, the wireless transmitting device being configured to:
obtain a compressed-mode PPDU that comprises one or more spatial configuration (SC) fields, wherein each SC field corresponds to one MU-MIMO group of the one or more MU-MIMO groups and is indicative of a spatial stream configuration for user devices of that MU-MIMO group; and
transmit the PPDU to the user devices of the one or more MU-MIMO groups over a predetermined bandwidth.

2. The wireless transmitting device according to claim 1, wherein the one or more SC fields of the PPDU comprise a first SC field and a second SC field, wherein the first SC field corresponds to a first MU-MIMO group and the second SC field corresponds to a second MU-MIMO group.

3. The wireless transmitting device according to claim 1, wherein the PPDU comprises one or more common fields and a user-specific field,
wherein the one or more common fields comprise one or more first information elements, wherein each first information element is to be used by all user devices of one associated MU-MIMO group, and
wherein the user-specific field comprises one or more second information elements, wherein each second information element is to be used by one associated user device.

4. The wireless transmitting device according to claim 3, wherein
the one or more SC fields are included in at least one of the one and more common fields.

5. The wireless transmitting device according to claim 3, wherein each SC field comprises a plurality of entries, wherein each entry corresponds to one user device of the MU-MIMO group that the SC field corresponds to, and the entry is indicative of a number of spatial streams allocated to the user device that the entry corresponds to, and an index of each spatial stream of the MU-MIMO group.

6. The wireless transmitting device according to claim 3, wherein a second information element of the user-specific field of the PPDU comprises at least one of a user position indication for the associated user device, and a user group indication for the associated user device, wherein the user position indication is indicative of an index of an entry within the SC field that the associated user device corresponds to, and the user group indication is indicative of the MU-MIMO group that the associated user device belongs to.

7. The wireless transmitting device according to claim 3, wherein a first information element of the one or more common signal fields of the PPDU comprises a compression mode field indicative of a type of compression mode that is applied by the wireless transmitting device, wherein the type of compression mode is indicative of how the predetermined bandwidth is allocated to the one or more MU-MIMO groups.

8. The wireless transmitting device according to claim 7, further configured to:
transmit the PPDU to the user devices of the one or more MU-MIMO groups according to the type of compression mode.

9. The wireless transmitting device according to claim 7, wherein the type of compression mode comprises one of: full bandwidth mode, and one of multiple enhanced compression modes, wherein each enhanced compression mode represents a resource allocation for the one or more MU-MIMO groups.

10. The wireless transmitting device according to claim 1, wherein the predetermined bandwidth comprises a primary segment and one or more secondary segments.

11. The wireless transmitting device according to claim 9, wherein the resource allocation indicates which segment of the predetermined bandwidth is allocated to which MU-MIMO group of the one or more MU-MIMO groups.

12. The wireless transmitting device according to claim 2, wherein, if the resource allocation indicates that a first subchannel is allocated to the first MU-MIMO group and that a second subchannel is allocated to the second MU-MIMO group, the first subchannel comprising at least the primary segment,
wherein information provided to user devices of the first MU-MIMO group is allocated in the first subchannel; and
information provided to user devices of the second MU-MIMO group is allocated in a second subchannel, wherein the second subchannel comprises segments of the predetermined bandwidth other than the segments comprised by the first subchannel.

13. The wireless transmitting device according to claim 2, wherein the one or more SC fields are replicated over each segment of the predetermined bandwidth.

14. The wireless transmitting device according to claim 7, wherein the compression mode field is replicated over each segment of the predetermined bandwidth.

15. The wireless transmitting device according to claim 2, wherein a first information element of the one or more common fields is indicative of a number of user devices in the associated MU-MIMO group.

16. The wireless transmitting device according to claim 10, wherein an indication of the number of user devices in each MU-MIMO group is replicated over each segment of the predetermined bandwidth.

17. The wireless transmitting device according to claim 1, wherein the predetermined bandwidth is 160 MHz, 240 MHz or 320 MHz.

18. A user device for a multi-user multi-input multi-output MU-MIMO group, the user device being configured to:
receive a compressed-mode physical layer protocol data unit PPDU, from a wireless transmitting device, which comprises one or more spatial configuration (SC) fields, wherein each SC field corresponds to one MU-MIMO group, and is indicative of a spatial stream configuration for user devices of that MU-MIMO group; and
decode the PPDU to obtain a SC field corresponding to the MU-MIMO group that the user device belongs to.

19. A method for a wireless transmitting device transmitting one or more physical layer protocol data units (PPDUs) to one or more multi-user multi-input multi-output (MU-MIMO) groups of user devices, the method comprising:
obtaining a compressed-mode PPDU that comprises one or more spatial configuration (SC) fields, wherein each SC field corresponds to one MU-MIMO group of the one or more MU-MIMO groups and is indicative of a spatial stream configuration for user devices of that MU-MIMO group; and
transmitting the PPDU to the user devices of the one or more MU-MIMO groups over a predetermined bandwidth.

20. A method for a user device of a multi-user multi-input multi-output (MU-MIMO) group, the method comprising:
receiving a compressed-mode physical layer protocol data unit (PPDU), from a wireless transmitting device, which comprises one or more spatial configuration (SC) fields, wherein each SC field corresponds to one MU-MIMO group and is indicative of a spatial stream configuration for user devices of that MU-MIMO group; and
decoding the PPDU to obtain a SC field corresponding to the MU-MIMO group that the user device belongs to.
